(19) United States
(12) Patent Application Publication
(10) Pub. No.: US 2006/0028570 A1
(43) Pub. Date: Feb. 9, 2006

(54) Solid state image capturing device and control method thereof

(76) Inventors: Yoshihiro Okada, Hashima-shi (JP); Shinichiro Izawa, Motosu-shi (JP); Hideki Takahashi, Gifu-shi (JP); Takashi Tanimoto, Motosu-gun (JP); Takahiko Ogo, Hashima-shi (JP)

Correspondence Address: CANTOR COLBURN, LLP, 55 GRIFFIN ROAD SOUTH, BLOOMFIELD, CT, 06002, US

(21) Appl. No.: 11/190,584

(22) Filed: Jul. 27, 2005

(30) Foreign Application Priority Data
Aug. 3, 2004 (JP) JP2004-226511

(51) Int. Cl. H04N 5/335

(52) U.S. Cl. 348/311

(57) ABSTRACT

A solid state image capturing device comprises a vertical transfer section including a plurality of vertical shift registers which vertically transfer information charges generated in a plurality of light-receiving pixels arranged in a matrix form, and a horizontal transfer section including a horizontal shift register in which each bit thereof is coupled to each of the vertical shift registers of the vertical transfer section, wherein the information charges corresponding to a plurality of light-receiving pixels transferred by the horizontal shift register are added and then horizontally transferred. Thus, transfer time of the information charges during horizontal transfer can be reduced.

### CROSS-REFERENCE TO RELATED APPLICATIONS

The entire disclosure of Japanese Patent Application No. 2004-226511 including specification, claims, drawings, and abstract is incorporated herein by reference.

### BACKGROUND OF THE INVENTION

1. Field of the Invention

The present invention relates to a solid state image capturing device in which transfer of information charges is increased in speed, and a control method thereof.

2. Description of the Related Art

FIG. 8 is a configuration diagram of a CCD solid state image capturing element 2 of a frame transfer type. The CCD solid state image capturing element 2 comprises an image capturing section 2i, a storage section 2s, a horizontal transfer section 2h and an output section 2d. The image capturing section 2i comprises a plurality of vertical shift registers arranged in parallel with each other in a vertical direction. Each bit of each vertical shift register constitutes a light-receiving pixel including a photoelectric conversion pixel, and stores information charges generated in accordance with intensity of light coming from the outside during image capture. During transfer, each bit, on receipt of a vertical clock pulse applied to a transfer electrode, transfers the information charges stored therein to the storage section 2s. The storage section 2s comprises vertical shift registers arranged in parallel with each other so as to continue from the vertical shift registers of the image capturing section. On receipt of the vertical clock pulse applied to the transfer electrode, the storage section 2s stores and vertically transfers the information charges transferred from the image capturing section 2i. The horizontal transfer section 2h comprises a horizontal shift register which is disposed at an output side of each of the vertical shift registers of the storage section 2s and in which each bit is coupled to an output of each vertical shift register of the storage section 2s. The horizontal transfer section 2h sequentially transfers, to the output section 2d, the information charges transferred from the storage section 2s. The output section 2d comprises a capacitance disposed at an output side of the horizontal transfer section 2h to store the information charges and convert them into a voltage. The output section 2d stores, in the capacitance, the information charges transferred from the horizontal transfer section 2h, and converts them into the voltage corresponding to an amount of charges, and then outputs the voltage as an output signal. A voltage value of this output signal will be an image signal.

Whenever one bit of information charges is transferred from the horizontal transfer section 2h, the output section 2d usually converts it into the voltage value and outputs it. The output section 2d further performs, on receipt of a reset clock, reset processing to discharge the information charges stored in the capacitance, and then performs outputting for the next one bit of information charges. At this time, the reset clock is input on a cycle twice as long as a cycle in which one bit of information charges is transferred from the horizontal transfer section 2h, so that two bits of information charges are stored in the capacitance of the output section 2d, thereby making it possible to obtain an image signal whose level is nearly twice as high as an ordinary level.

Thus, the information charges for a plurality of pixels are added to increase intensity of the image signal, and the image signal at a satisfactory level can be obtained without causing underexposure even when an image of a dark subject is captured.

However, in a CCD solid state image capturing device intended to capture color images, red (R), green (G) and blue (B) color filters are arranged in a tessellated manner to correspond to the light-receiving pixels of the image capturing section 2i as shown in FIG. 9, and if multiple bits of information charges transferred from the horizontal transfer section 2h are added as described above, a problem is caused in that the information charges for different colors are mixed and colors of the color image cannot be correctly reproduced. Further, because this device does not add and then transfer the information charges during horizontal transfer, horizontal transfer time is equal to the time to transfer one bit, which is incompatible with requirements for high-speed transfer.

In order to solve the problem of color reproducibility in such a solid state image capturing device which captures the color images, a solid state image capturing device has been disclosed wherein each bit of the horizontal shift register of the horizontal transfer section is disposed to correspond to each combination of an odd line and an even line of the vertical shift registers of the storage section, and control is performed so that the information charges are alternately transferred from the odd line and the even line of the vertical shift registers during every horizontal transfer period. However, the horizontal transfer period still remains unchanged from a conventional one in this configuration.

In recent CCD solid state image capturing elements with higher resolution, the number of stages to transfer the information charges has increased and the transfer time has become longer, along with an increase in the number of pixels. Therefore, there is an increasing demand that when a low-resolution image is to be acquired, a transfer speed should be improved compared with that when a high-resolution image is acquired.

However, in the above-mentioned prior art method in which the information charges are added in the output section, or a method in which each bit of the horizontal shift register is matched to the combination of the vertical shift registers of the odd line and the even line, there is no alternative but to increase the frequency of the transfer clock pulse in order for the transfer period of the information charges in the horizontal transfer section to be shorter than it has been previously. It is necessary to increase complexity and size of peripheral circuits to increase the frequency of the transfer clock pulse, which leads to a problem of increased power consumption. Further, the increase in frequency requires a characteristic improvement in the entire system, such as an increase in noise resistance properties in the output section, which further causes difficulty in developing the device.

### SUMMARY OF THE INVENTION

A first aspect of the present invention is directed to a solid state image capturing device provided with a solid state image capturing element, the element comprising a vertical transfer section including a plurality of vertical shift registers which vertically transfer information charges generated in a plurality of light-receiving pixels arranged in a matrix form; a horizontal transfer section including a horizontal shift register in which each bit thereof is coupled to each of the vertical shift registers of the vertical transfer section; and an output section which outputs an output signal corresponding to an amount of information charges transferred from the horizontal shift register of the horizontal transfer section, wherein the information charges corresponding to the plurality of light-receiving pixels transferred to the horizontal shift register are added and then horizontally transferred.

A second aspect of the present invention is directed to a method of controlling a solid state image capturing device provided with a solid state image capturing element, the element comprising a vertical transfer section including a plurality of vertical shift registers which vertically transfer information charges generated in a plurality of light-receiving pixels arranged in a matrix form; a horizontal transfer section including a horizontal shift register in which each bit thereof is coupled to each of the vertical shift registers of the vertical transfer section; and an output section which outputs an output signal corresponding to an amount of information charges transferred from the horizontal shift register of the horizontal transfer section, wherein the information charges corresponding to the plurality of light-receiving pixels transferred by the horizontal shift register are added and then horizontally transferred.

### BRIEF DESCRIPTION OF THE DRAWINGS

Preferred embodiments of the present invention will be described in further detail based on the following drawings, wherein:

FIG. 1 is a diagram showing a configuration of a solid state image capturing device in an embodiment of the present invention;

FIG. 2 is an enlarged view of a configuration of essential parts in the solid state image capturing device in the embodiment of the present invention;

FIG. 3 is a timing chart of clock pulses for controlling the solid state image capturing device in the embodiment of the present invention;

FIG. 4 is a timing chart of the clock pulses for controlling the solid state image capturing device in the embodiment of the present invention;

FIG. 5 is a diagram showing potential changes in a horizontal transfer section in the embodiment of the present invention;

FIG. 6 is a timing chart showing output changes in the embodiment of the present invention;

FIG. 7 is a diagram showing the potential changes in the horizontal transfer section in a modification of the embodiment of the present invention;

FIG. 8 is a diagram showing a configuration of a solid state image capturing element in the related art; and

FIG. 9 is a diagram showing an arrangement of color filters of the solid state image capturing element in the related art.

### DESCRIPTION OF THE PREFERRED EMBODIMENTS

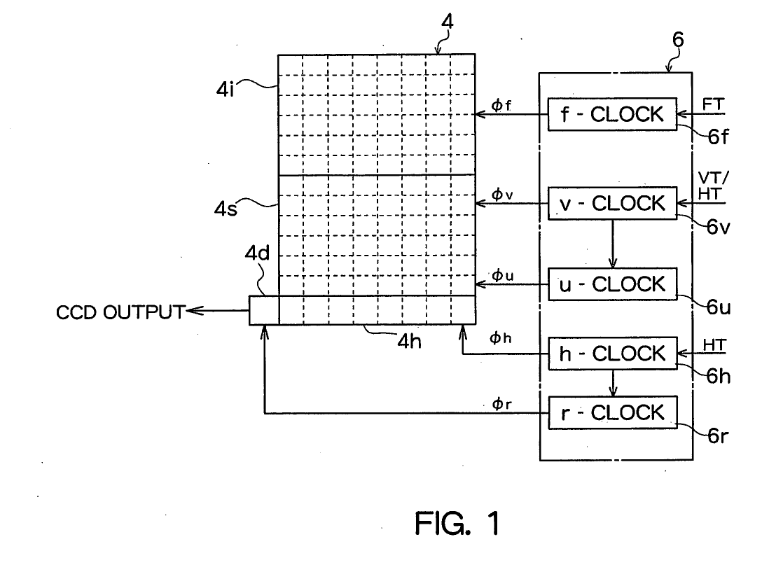

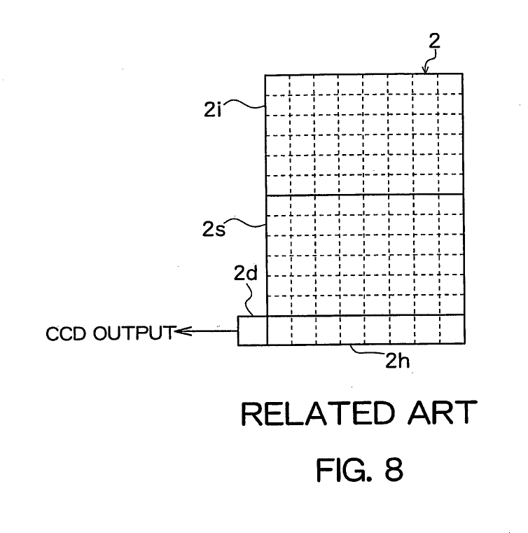

A solid state image capturing device in the present embodiment comprises a CCD solid state image capturing element 4 and a driving circuit 6, as shown in FIG. 1. The CCD solid state image capturing element 4 of a frame transfer type comprises an image capturing section 4i, a storage section 4s, a horizontal transfer section 4h and an output section 4d, in the same manner as in FIG. 8. The driving circuit 6 comprises a frame clock pulse generation section 6f, a vertical clock pulse generation section 6v, an auxiliary clock pulse generation section 6u, a horizontal clock pulse generation section 6h and a reset clock pulse generation section 6r. The CCD solid state image capturing element 4 is controlled by receiving various clock pulses from the driving circuit 6.

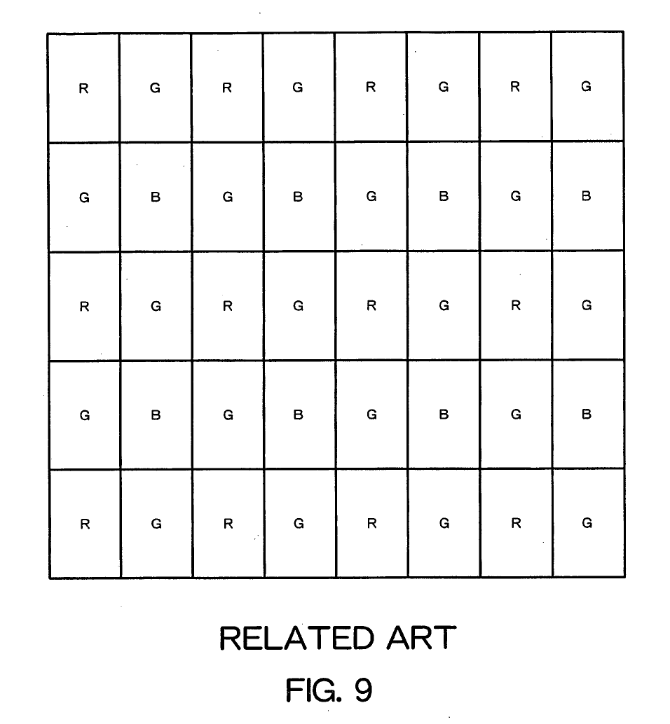

The image capturing section 4i comprises a plurality of vertical shift registers arranged in parallel with each other in a vertical direction. Each bit of each vertical shift register constitutes a light-receiving pixel including a photoelectric conversion pixel. Each bit stores information charges generated in accordance with intensity of light coming from the outside during image capture. In the image capturing section 4i in the present embodiment, red (R), green (G) and blue (B) color filters are arranged in a tessellated manner to correspond to the light-receiving pixels, as has been shown in FIG. 9. That is, the light-receiving pixels which store the information charges corresponding to the red (R) and the green (G) are alternately arranged along a transfer direction in odd lines of the vertical shift register, while the light-receiving pixels which store the information charges corresponding to the green (G) and the blue (B) are alternately arranged along the transfer direction in even lines of the vertical shift register. During image capturing, only a wavelength component of a color of each color filter out of the light coming from the outside is transmitted, so that the information charges corresponding to the intensity of light having this wavelength component are stored in each pixel. During transfer, a vertical clock pulse φ_{f} is applied from the frame clock pulse generation section 6f to a transfer electrode of the image capturing section 4i, and the information charges stored in each pixel are transferred to the storage section 4s.

The storage section 4s comprises vertical shift registers arranged in parallel with each other so as to continue from the vertical shift registers of the image capturing section 4i. A vertical clock pulse φᵥ is applied from the vertical clock pulse generation section 6v to a transfer electrode of the storage section 4s, and the information charges transferred from the image capturing section 4i are stored in the storage section 4s and also transferred in the vertical direction. The horizontal transfer section 4h comprises a horizontal shift register disposed at an output side of each vertical shift register of the storage section 4s. A horizontal clock pulse φₕ is applied from the horizontal clock pulse generation section 6h to a horizontal transfer electrode of the horizontal transfer section 4h, and the information charges transferred from the storage section 4s are sequentially transferred to the output section 4d. The output section 4d comprises a capacitance disposed at an output side of the horizontal transfer section 4h. A reset clock pulse φᵣ is applied from the reset clock pulse generation section 6r to the output section 4d, which resets the capacitance to an initial voltage. Then, the information charges transferred from the horizontal transfer section 4h are stored in this capacitance. Further, a voltage corresponding to an amount of stored charges is output as an output signal. A voltage value of this output signal will be an image signal.

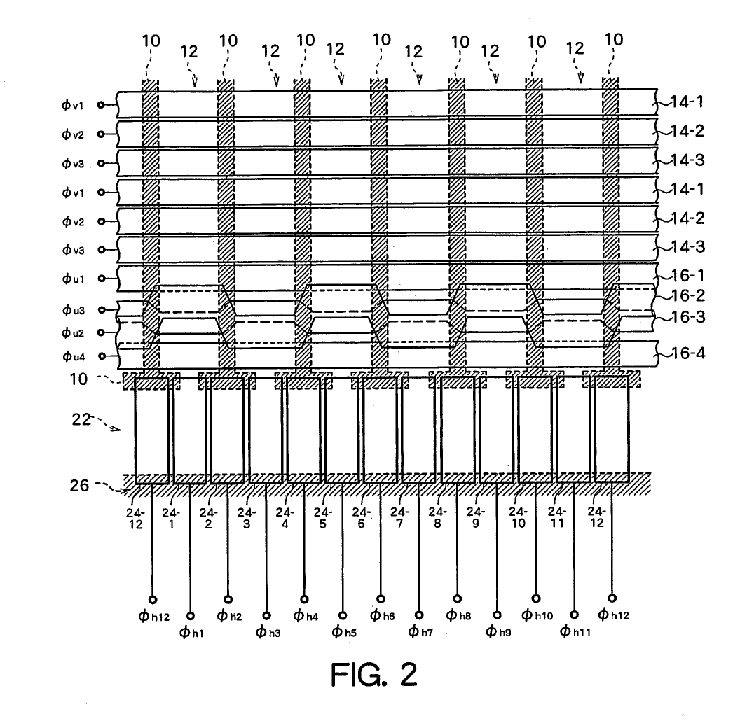

FIG. 2 is a plan view showing an internal configuration of a connection portion between the storage section 4s and the horizontal transfer section 4h of the CCD solid state image capturing element 4 in the present embodiment. The storage section 4s comprises a plurality of vertical shift registers extending in parallel with each other. The vertical shift register is formed as follows. A P-well (PW) which is a P-type diffused layer is formed in an N-type semiconductor substrate, on which an N-well that is an N-type diffused layer is formed. Further, separation areas 10 to which P-type impurities are added are provided at predetermined intervals in parallel with each other along a direction in which the vertical shift registers extend. The N-well is electrically partitioned by the adjacent separation areas 10. An area sandwiched by the separation areas 10 is a channel area 12 which is a transfer path of the information charges. The separation area 10 forms a potential barrier between the adjacent channel areas, and electrically separates the channel areas 12. Further, an insulating film is formed on a surface of the semiconductor substrate. On this insulating film, a plurality of transfer electrodes 14 comprising polysilicon films is arranged in parallel with each other so as to be orthogonal to a direction in which the channel areas 12 extend. The present embodiment employs a vertical transfer scheme based on three-phase vertical clock pulses φᵥ₁ to φᵥ₃, and a set of three transfer electrodes 14-1, 14-2, 14-3 adjacent along a vertical transfer direction corresponds to one pixel. However, a scope in which the present invention is applied is not limited to the three-phase transfer scheme, and the present invention can also be applied to different transfer schemes such as a two-phase or four-phase transfer scheme. It is to be noted that the vertical shift registers of the image capturing section 4i can also be configured in the same manner, and are arranged to continue from the vertical shift registers of the storage section 4s.

The horizontal transfer section 4h comprises horizontal shift registers which receive and transfer the information charges output from the vertical shift registers of the storage section 4s. The horizontal shift register comprises a channel area 22 and a horizontal transfer electrode 24. The channel area 22 is partitioned in a direction orthogonal to the direction in which the vertical shift registers extend by the separation areas 10 extending from the vertical shift registers of the storage section 4s and by a horizontal separation area 26 which is provided facing the storage section 4s and which is a P-type diffused layer. The channel areas 12 of the vertical shift registers and the channel area 22 of the horizontal shift register are connected via gaps between the extending separation areas 10.

Auxiliary transfer electrodes 16-1 to 16-4 are formed in a connection area between the storage section 4s and the horizontal transfer section 4h. The auxiliary transfer electrodes 16-1 to 16-4 are formed as multi-layered electrodes electrically insulated from each other by means of insulation films. The auxiliary transfer electrode 16-1 is disposed farthest from the horizontal shift register in parallel with the transfer electrodes 14 at a predetermined distance from the transfer electrode 14. The auxiliary transfer electrode 16-4 is disposed closest from the horizontal shift register in parallel with the transfer electrodes 14. The auxiliary transfer electrodes 16-2, 16-3 are disposed in an area between the auxiliary transfer electrodes 16-1 and 16-4 so that they partially overlap the auxiliary transfer electrodes 16-1 and 16-4 by means of insulating films. The auxiliary transfer electrode 16-3 is disposed in parallel with the transfer electrodes 14 in a zigzag line so as to be close to the horizontal shift register in the odd lines and to be away from the horizontal shift register in the even lines. The auxiliary transfer electrode 16-2 is disposed on the auxiliary transfer electrode 16-3 via an insulating film in a zigzag line so as to be away from the horizontal shift register in the odd lines and to be close to the horizontal shift register in the even lines. Here, the an upper-layer-side auxiliary transfer electrode 16-2 is disposed to overlap the lower-layer-side auxiliary transfer electrode 16-3 in the channel areas 12 of the odd lines so that a voltage applied to the upper-layer-side auxiliary transfer electrode 16-2 only works on the channel areas 12 of the even lines. That is, the auxiliary transfer electrodes 16-1 and 16-4 form one auxiliary bit at an output terminal of the channel area 12 of the even line. By applying four-phase auxiliary clock pulses φᵤ₁ to φᵤ₄ to the auxiliary transfer electrodes 16-1 to 16-4, respectively, the information charges for one pixel can be temporarily stored in the channel area 12 of the even line in the process of transferring the information charges from the storage section 4s to the horizontal transfer section 4h. It is to be noted that the auxiliary transfer electrodes 16 are not limited to the four-phase control, but may be configured so that the information charges in the even line can be delayed by one pixel with respect to the odd line to vertically transfer and output the information charges.

The horizontal transfer electrode 24 is formed on the channel area 22 extending in a direction orthogonal to the vertical shift registers. Two horizontal transfer electrodes 24 are disposed for each vertical shift register, in a sequential order from the vertical shift register of the odd line adjacent to the output section 4d of the horizontal shift register. In the present embodiment, twelve horizontal transfer electrodes 24-1 to 24-12 form a set, and they are sequentially arranged along a transfer direction of the horizontal shift register. Here, the horizontal transfer electrodes 24-1, 24-3, 24-5, 24-7, 24-9, 24-11 arranged to extend from the channel areas 12 of the vertical shift registers are located on the channel area 22 via insulating films so as to stretch from the channel areas 12 to the horizontal separation area 26. The horizontal transfer electrodes 24-2, 24-4, 24-6, 24-8, 24-10, 24-12 are located on the channel area 22 via insulating films so as to stretch from the separation areas 10 to the horizontal separation area 26. In the present embodiment, control is performed by applying mutually independently controllable horizontal clock pulses φₕ₁ to φₕ₁₂ to the twelve horizontal transfer electrodes 24-1 to 24-12 corresponding to the six sequential vertical shift registers along a horizontal transfer direction.

Next, components of the driving circuit 6 will be described. The frame clock pulse generation section 6f generates a three-phase frame clock pulse φ_{f} in response to a frame shift timing signal FT supplied from the outside, and then supplies it to the transfer electrode of the vertical shift register of the image capturing section 4i. This frame clock φ_{f} causes the information charges stored in the light-receiving pixels of the image capturing section 4i to be transferred to the storage section 4s during every vertical scanning period. The vertical clock pulse generation section 6v generates a three-phase vertical clock pulse φᵥ in response to a vertical synchronization signal VT and a horizontal synchronization signal HT, and then supplies it to the transfer electrode of the vertical shift register of the storage section 4s. In the present embodiment, the three sequentially arranged transfer electrodes 14-1 to 14-3 correspond to one horizontal line in the image capturing section 4i and the storage section 4s. Thus, by applying, as the frame clock pulse φ_{f} and the vertical clock pulse φᵥ, three-phase clock pulses which change in different phases to the transfer electrodes 14-1 to 14-3, the information charges can be vertically transferred per horizontal line. The horizontal clock pulse generation section 6h generates the horizontal clock pulse φₕ in response to the horizontal synchronization signal HT, and supplies it to the horizontal transfer electrodes 24 of the horizontal transfer section 4h. Here, it should be appreciated that the horizontal clock pulse generation section 6h can generate the mutually independently controllable horizontal clock pulses φₕ for the horizontal transfer electrodes 24 coupled to sequential 2n vertical shift registers when the information charges of n pixels are added in the horizontal shift register and thus transferred. In the present embodiment, since the information charges for three pixels are added, it is possible to generate mutually independently controlled twelve-phase horizontal clock pulses φₕ intended for the twelve horizontal transfer electrodes 24-1 to 24-12 coupled to six vertical shift registers. The auxiliary clock pulse generation section 6u generates, in response to the horizontal synchronization signal HT, a four-phase auxiliary clock pulse φᵤ having a period half as long as a transfer period of one bit of a vertical clock pulse φᵥ, and supplies it to the auxiliary transfer electrodes 16. This vertical clock pulse φᵤ causes the information charges transferred through the vertical shift registers of the storage section 4s to be transferred to the horizontal transfer section 4h alternately between the odd lines and even lines. Control by use of the vertical clock pulse φᵥ, the horizontal clock pulses φₕ and the vertical clock pulses φᵤ will be described later.

The reset clock pulse generation section 6r generates the reset clock pulse φᵣ synchronously with the horizontal clock pulse φₕ generated in the horizontal clock pulse generation section 6h, and supplies it to the output section 4d. This reset clock pulse φᵣ is supplied to a gate of a switching element which connects the capacitance of the output section 4d and a deep portion of the substrate, and is used to discharge the information charges stored in the capacitance of the output section 4d to the substrate.

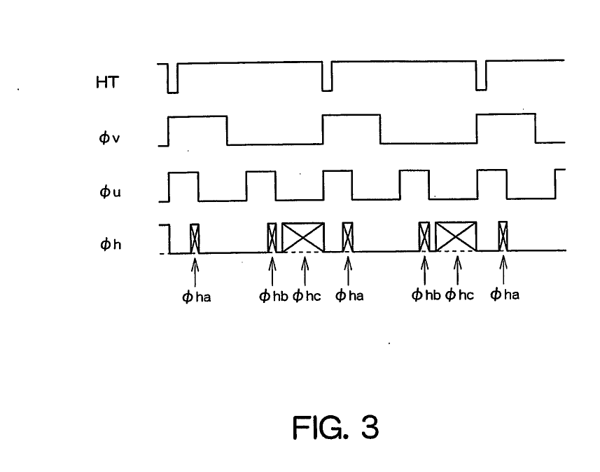

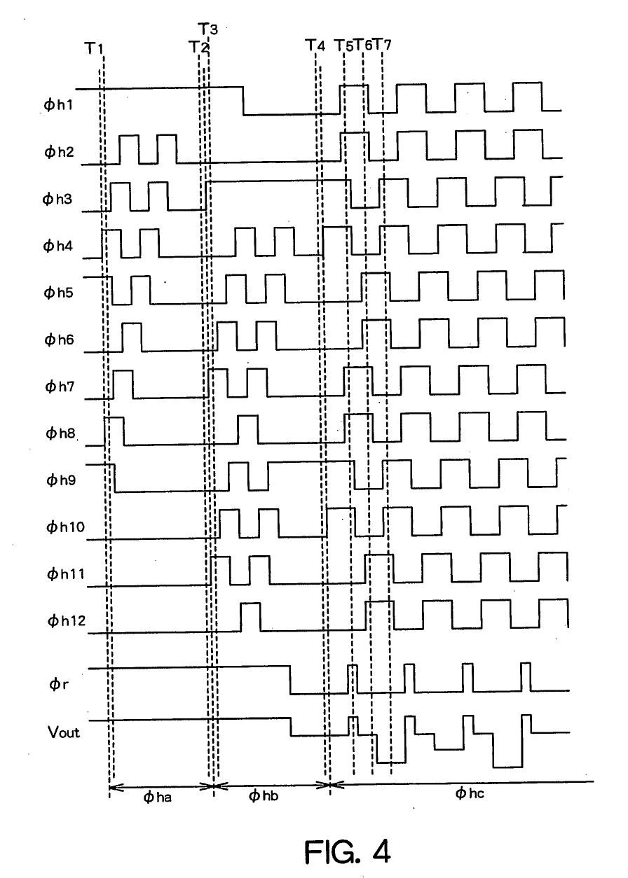

FIGS. 3 and 4 show timing charts of the clock pulses when the solid state image capturing device in the present embodiment is used to perform high-speed transfer with reduced resolution of an image. FIG. 3 shows a relationship among the horizontal synchronization signal HT, the vertical clock pulse φᵥ, the auxiliary clock pulse φᵤ and the horizontal clock pulse φₕ. FIG. 4 shows how the horizontal clock pulses φₕ, the reset clock pulse φᵣ and an output signal Vₒᵤₜ change during horizontal transfer. In FIG. 4, an upper side of a vertical axis indicates a positive voltage and a lower side thereof indicates a negative voltage. It is to be noted that the vertical clock pulse φᵥ is three-phase and the auxiliary clock pulse φᵤ is four-phase, but only representative clocks are shown in FIG. 3.

The vertical clock pulse φᵥ is applied to the transfer electrodes 14-1 to 14-3 on a cycle corresponding to the horizontal synchronization signal HT. The vertical clock pulse φᵥ comprises the three-phase pulses φᵥ₁ to φᵥ₃ which change in phases different from each other. This causes the information charges to be transferred along the channels 12 of the vertical shift registers per horizontal line during one horizontal transfer period. The auxiliary clock pulse φᵤ is applied to the auxiliary transfer electrodes 16-1 and 16-4 so as to correspond to a period half as long as the horizontal synchronization signal HT. Since the auxiliary transfer electrodes 16-1 and 16-4 only effectively work at output terminals of the vertical shift registers in the even lines as described above, a potential state is controlled in the channels 12 of the vertical shift registers in the even lines so that an amount corresponding to two pixels is transferred during one horizontal transfer period. At this point, since the vertical clock pulse φᵥ causes only the information charges for one pixel to be transferred during one horizontal transfer period from the transfer electrodes 14-1 to 14-3 to the auxiliary transfer electrodes 16-1 to 16-4, the information charges for one pixel are transferred to the horizontal shift register at such a time as to produce a difference corresponding to a period half as long as a vertical transfer period between the vertical shift register in the even line and the vertical shift register in the odd line.

The horizontal clock pulse φₕ is generated in accordance with the vertical clock pulse φᵥ and the auxiliary clock pulse φᵤ, and applied to the horizontal transfer electrodes 24-1 to 24-12 during a period shorter than the horizontal transfer period. In the present embodiment, the horizontal clock pulse φₕ comprises a combination of charge synthesis clock pulses φₕₐ, φ_{hb} and a charge transfer clock pulse φ_{hc}. This causes the information charges for a plurality of pixels corresponding to the same wavelength region (the same color) included in one horizontal line to be added in the horizontal shift register and transferred to the output section 4d.

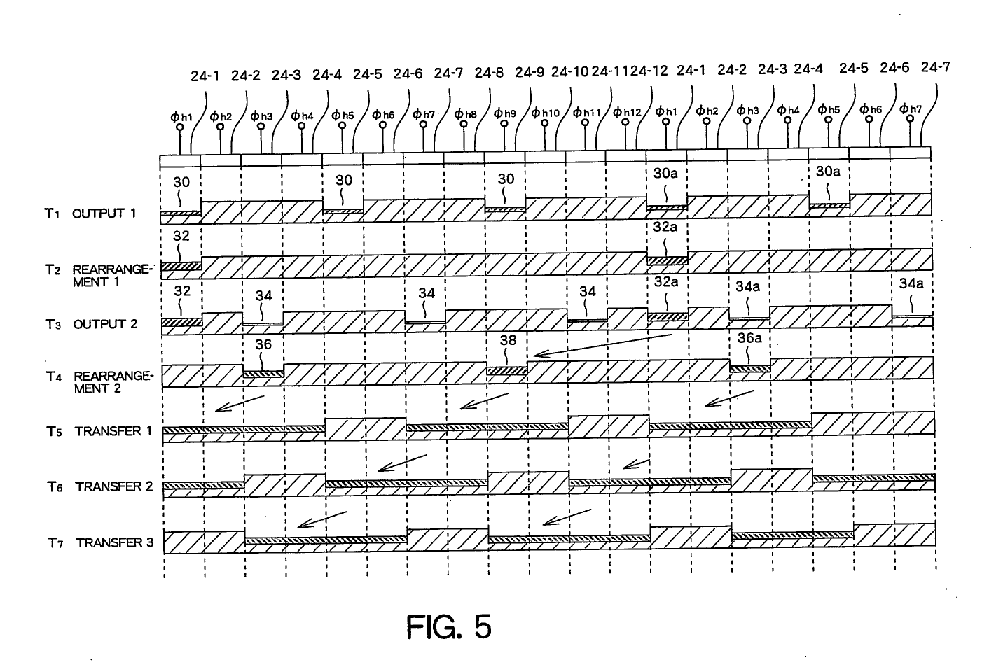

FIG. 5 shows a state of a potential well formed in the horizontal shift register when the horizontal clock pulse φₕ is applied. In FIG. 5, a horizontal axis indicates positions corresponding to the horizontal transfer electrodes 24-1 to 24-12, while an upper side of a vertical axis indicates potentials having a positive voltage and a lower side thereof indicates potentials having a negative voltage.

In the present embodiment, horizontal clock pulses φₕ₁ to φₕ₁₂ applied to the horizontal transfer electrodes 24-1 to 24-12 are independently controlled to add the information charges for three pixels corresponding to the same color. At time T₁, the horizontal clock pulses φₕ₁, φₕ₅, φₕ₉ applied to the horizontal transfer electrodes 24-1, 24-5, 24-9 are brought to a high level, and the information charges transferred from the odd lines of the vertical shift registers are stored in potential wells 30 (30a) formed under the horizontal transfer electrodes 24-1, 24-5, 24-9. For example, the information charges corresponding to the wavelength region of the red (R) in the odd lines are transferred to the horizontal shift register. Then, the horizontal clock pulses φₕ₁ to φₕ₉ are sequentially changed until time T₂, so that the information charges stored in the potential wells 30 (30a) formed under the horizontal transfer electrodes 24-5, 24-9 are rearranged in a potential well 32 (32a) formed under the horizontal transfer electrode 24-1. Subsequently, at time T₃, the horizontal clock pulses φₕ₃, φₕ₇, φₕ₁₁ applied to the horizontal transfer electrodes 24-3, 24-7, 24-11 are brought to a high level, and the information charges transferred from the even lines of the vertical shift registers are stored in potential wells 34 (34a) formed under the horizontal transfer electrodes 24-3, 24-7, 24-11. Here, the information charges corresponding to the wavelength region of the green (G) which have been on the same horizontal line as the information charges corresponding to the wavelength region of the red (R) transferred at time T₁ are transferred to the horizontal shift register. Then, the horizontal clock pulses φₕ₁ to φₕ₁₂ are sequentially changed until time T₄, so that the information charges stored in the potential wells 34 (34a) formed under the horizontal transfer electrodes 24-7, 24-11 are rearranged in a potential well 36 (36a) formed under the horizontal transfer electrode 24-3. At the same time, the information charges stored in the potential well 32 (32a) formed under the horizontal transfer electrode 24-1 are sequentially transferred farther in the horizontal transfer direction to a potential well 38 (38a) formed under the horizontal transfer electrode 24-9. At this point, the information charges stored in the potential well formed under the horizontal transfer electrode 24-1 at an output terminal of the horizontal shift register are transferred to the output section 4d.

It is to be noted that the addition and synthesis of the information charges in the horizontal shift register are not limited to the above, and the addition and synthesis may be performed in any manner as long as the information charges corresponding to wavelength regions of different colors included in one horizontal line are not mixed. For example, when the information charges included in one horizontal line correspond to different colors depending on whether they are in the even lines or in the odd lines of the vertical shift registers as in the present embodiment, the information charges in the even lines and the information charges in the odd lines may be separately added.

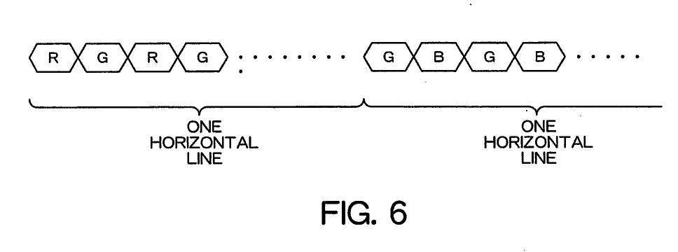

The information charges of one horizontal line are thus added for every three pixels, and then, adjacent two of the horizontal transfer electrodes 24-1 to 24-12 form one set, so that the three-phase horizontal clock pulses φₕ in phase are applied to one set of electrodes, thereby horizontally transferring the information charges. That is, as shown in a period of the horizontal clock pulse φ_{hc} in FIG. 4, in the present embodiment, sets are formed by two horizontal transfer electrodes 24-1 and 24-2, two horizontal transfer electrodes 24-3 and 24-4, two horizontal transfer electrodes 24-5 and 24-6 . . . corresponding to the vertical shift registers, and the horizontal clock pulses φₕ₁ to φₕ₁₂ substantially in three pulses are applied to the adjacent three sets of horizontal transfer electrodes so as to add the information charges, thereby horizontally transferring the information charges. Thus, at times T₅ to T₇, the information charges stored in the potential wells 36, 38 are sequentially transferred to the output section 4d along the horizontal transfer direction. This horizontal transfer is sequentially repeated to convert the information charges of one horizontal line into an output signal and then output the output signal. When the horizontal transfer for one horizontal line is completed, vertical transfer of the next horizontal line will follow, as shown in FIG. 3. At this point, as shown in FIG. 6, the information charges corresponding to the wavelength regions of the red (R) and the green (G) or the green (G) and the blue (B) included in one horizontal line are alternately output from the output section 4d.

As described above, in the present embodiment, the information charges for three pixels corresponding to the wavelength region of the same color are added in the horizontal transfer direction before being horizontally transferred. In this way, the number of transfer stages can be practically reduced, and the transfer time of the information charges during the horizontal transfer can be shorter than it has been previously without increasing fundamental frequencies of the clock pulses. Therefore, when a low-resolution image is to be obtained, the image can be obtained at high speed.

Furthermore, if the horizontal clock pulse φₕ is configured so that sixteen phases thereof are independently controllable and if the sixteen horizontal transfer electrodes 24 coupled to the sequential eight vertical shift registers are controlled by this horizontal clock pulse φₕ, the information charges for four pixels can be added before being horizontally transferred. When the information charges for n pixels are further to be added and thus transferred, this can be achieved in such a manner that the mutually independently controllable horizontal clock pulses φₕ are supplied to the horizontal transfer electrodes 24 coupled to the sequential 2n vertical shift registers. However, it is necessary to complicate and enlarge a circuit configuration of the horizontal clock pulse generation section 6h and to increase the number of pins provided in a chip of the CCD solid state image capturing element 4 in order to increase the number of phases of the independently controlled horizontal clock pulses φₕ, and these need to be taken into consideration to determine the number of phases of the horizontal clock pulses φₕ.

Still further, the CCD solid state image capturing device for capturing color images in which the color filters are arranged in a tessellated manner has been described by way of example in the present embodiment, but the present invention can also be applied to the CCD solid state image capturing device for capturing black-and-white images. In this case, it is not necessary to consider the mixing of the information charges corresponding to different colors, and the auxiliary transfer electrodes 16 do not need to be provided at a joint between a storage section 4s and a horizontal transfer section 4h. When the information charges for n pixels are added for the black-and-white image, the mutually independently controllable horizontal clock pulses φₕ may be supplied to the horizontal transfer electrodes 24 coupled to the sequential n vertical shift registers.

In addition, when it is desired to output a high-resolution image signal without adding the information charges, the horizontal shift register may be controlled by the four-phase horizontal clock pulse φₕ so that horizontal transfer is performed for each of the information charges for one pixel, as has heretofore been done.

<Modification>

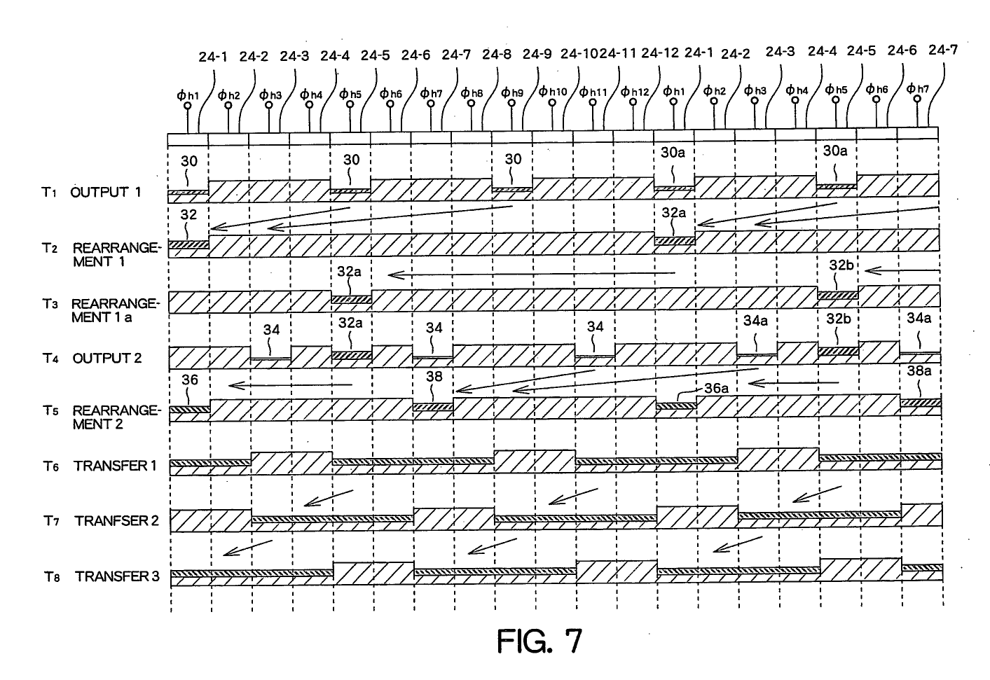

A modification of the above-mentioned embodiment will be described using FIG. 7. In the above-mentioned embodiment, information charges transferred from vertical shift registers corresponding to the same horizontal transfer electrodes 24-1 to 24-12 are added in both odd lines and even lines of the vertical shift registers. However, such a method of addition and synthesis reduces spatial frequency of a horizontal image. Thus, in the present modification, the information charges transferred from the vertical shift registers corresponding to the horizontal transfer electrodes belonging to the same set are added in one of the odd lines and even lines of the vertical shift registers, while the information charges transferred from the vertical shift registers corresponding to the horizontal transfer electrodes belonging to another adjacent set are added and then transferred in the other one of the odd lines and even lines of the vertical shift registers.

At time T₁, horizontal clock pulses φₕ₁, φₕ₅, φₕ₉ applied to the horizontal transfer electrodes 24-1, 24-5, 24-9 are brought to a high level, and the information charges transferred from the odd lines of the vertical shift registers are stored in potential wells 30 (30a) formed under the horizontal transfer electrodes 24-1, 24-5, 24-9. For example, the information charges corresponding to a wavelength region of red (R) in the odd lines are transferred to a horizontal shift register. Then, the horizontal clock pulses φₕ₁ to φₕ₉ are sequentially changed until time T₂, so that the information charges stored in the potential wells 30 (30a) formed under the horizontal transfer electrodes 24-5, 24-9 are added in a potential well 32 (32a) formed under the horizontal transfer electrode 24-1. Further, at time T₃, the information charges stored in the potential well 32 (32a, 32b) are transferred in a horizontal transfer direction, and retained under the horizontal transfer electrode 24-5 of the next set.

Subsequently, at time T₄, horizontal clock pulses φₕ₃, φₕ₇, φₕ₁₁, applied to the horizontal transfer electrodes 24-3, 24-7, 24-11 are brought to a high level, and the information charges transferred from the even lines of the vertical shift registers are stored in potential wells 34 (34a) formed under the horizontal transfer electrodes 24-3, 24-7, 24-11. Here, the information charges corresponding to a wavelength region of green (G) which have been on the same horizontal line as the information charges corresponding to the wavelength region of the red (R) transferred at time T₁ are transferred to the horizontal shift register. Then, the horizontal clock pulses φₕ₁ to φₕ₁₂ are sequentially changed until time T₅, so that the information charges stored in the potential wells 34 formed under the horizontal transfer electrodes 24-7, 24-11 and in the potential wells 34a formed under the horizontal transfer electrode 24-3 included in a set next to the former are added in a potential well 38 formed under the horizontal transfer electrode 24-7. At the same time, the information charges retained in a potential well 36 under the horizontal transfer electrode 24-5 are transferred in the horizontal transfer direction, and sequentially transferred under the horizontal transfer electrode 24-1. Subsequently, the added information charges are transferred in the horizontal transfer direction as in the embodiment described above.

Thus, the information charges transferred from the vertical shift registers corresponding to the horizontal transfer electrodes belonging to the same set are added in a case of the odd lines (even lines) of the vertical shift registers, while the information charges are added so as to stretch to the horizontal transfer electrodes belonging to another adjacent set in a case of the even lines (odd lines) of the vertical shift registers. This makes it possible to improve a spatial frequency characteristic in a horizontal direction of an image signal.

As described above, according to the present invention, transfer time of the information charges during the horizontal transfer can be reduced without increasing fundamental frequencies of the clock pulses. Therefore, when a low-resolution image is to be obtained, the image can be obtained at high speed.

It is to be noted that a scope in which the present invention can be applied is not limited to the CCD solid state image capturing device of the frame transfer type. The technical concept of the present invention can be applied to any device as long as it is a device in which the information charges are vertically transferred from a screen comprising a plurality of pixels arranged in a matrix form, and then the information charges corresponding to each row are horizontally transferred and thus output.

What is claimed is:

1. A solid state image capturing device provided with a solid state image capturing element,
the element comprising:
a vertical transfer section including a plurality of vertical shift registers which vertically transfer information charges generated in a plurality of light-receiving pixels arranged in a matrix form;
a horizontal transfer section including a horizontal shift register in which each bit thereof is coupled to each of the vertical shift registers; and
an output section which outputs an output signal corresponding to an amount of information charges transferred from the horizontal shift register,
wherein the information charges corresponding to the plurality of light-receiving pixels transferred to the horizontal shift register are added and then horizontally transferred.

2. The solid state image capturing device according to claim 1, wherein
the horizontal shift register comprises a plurality of horizontal transfer electrodes arranged in parallel with each other along a horizontal transfer direction so as to correspond to the vertical shift registers, and
the solid state image capturing device comprises a driving circuit which generates mutually independently controllable horizontal clock pulses for the respective horizontal transfer electrodes included in one set, the one set including the horizontal transfer electrodes corresponding to at least six sequential vertical shift registers along the horizontal transfer direction.

3. The solid state image capturing device according to claim 1, wherein
in the horizontal transfer section, the information charges transferred from odd lines and even lines of the vertical shift registers are separately added before being horizontally transferred.

4. The solid state image capturing device according to claim 2, wherein
in the horizontal transfer section, the information charges transferred from odd lines and even lines of the vertical shift registers are separately added before being horizontally transferred.

5. The solid state image capturing device according to claim 3, wherein
at a joint region between the vertical shift registers and the horizontal shift register, there is disposed an auxiliary transfer electrode to which an auxiliary clock pulse is applied, the auxiliary clock pulse being controlled independently of vertical clock pulses applied to the vertical shift registers and the horizontal clock pulses applied to the horizontal shift registers, and
due to an effect of the auxiliary clock pulse, the information charges transferred in the odd lines of the vertical shift registers and the information charges transferred in the even lines thereof are transferred to the horizontal shift register at different points of time.

6. The solid state image capturing device according to claim 4, wherein
at a joint region between the vertical shift registers and the horizontal shift register, there is disposed an auxiliary transfer electrode to which an auxiliary clock pulse is applied, the auxiliary clock pulse being controlled independently of vertical clock pulses applied to the vertical shift registers and the horizontal clock pulses applied to the horizontal shift registers, and
due to an effect of the auxiliary clock pulse, the information charges transferred in the odd lines of the vertical shift registers and the information charges transferred in the even lines thereof are transferred to the horizontal shift register at different points in time.

7. The solid state image capturing device according to claim 2, wherein
in the horizontal transfer section, the information charges transferred from one of the odd lines and even lines of the vertical shift registers are added so as to stretch over the horizontal transfer electrodes included in at least two sets and then transferred.

8. A method of controlling a solid state image capturing device provided with a solid state image capturing element,
the element comprising:
a vertical transfer section including a plurality of vertical shift registers which vertically transfer information charges generated in a plurality of light-receiving pixels arranged in a matrix form;
a horizontal transfer section including a horizontal shift register in which each bit thereof is coupled to each of the vertical shift registers; and
an output section which outputs an output signal corresponding to an amount of information charges transferred from the horizontal shift register,
wherein the information charges corresponding to the plurality of light-receiving pixels transferred by the horizontal shift register are added and then horizontally transferred.

9. The method of controlling the solid state image capturing device according to claim 8, wherein
the horizontal shift register comprises a plurality of horizontal transfer electrodes arranged in parallel with each other in a horizontal transfer direction so as to correspond to the vertical shift registers, and
mutually independently controllable horizontal clock pulses are applied to the respective horizontal transfer electrodes included in one set to add and then transfer the information charges, the one set including the horizontal transfer electrodes corresponding to at least six sequential vertical shift registers along the horizontal transfer direction.

10. The method of controlling the solid state image capturing device according to claim 9, wherein
the information charges transferred from one of the odd lines and even lines of the vertical shift registers are added so as to stretch over the horizontal transfer electrodes included in at least two sets and then transferred.
